(19) United States
(12) Patent Application Publication
(10) Pub. No.: US 2009/0251413 A1
(43) Pub. Date: Oct. 8, 2009

(54) Computer Switching Device

(76) Inventor: Matthew Winchester, Newton Abbot (GB)

Correspondence Address: Law Office of Ira S. Dorman, 330 Roberts Street, Suite 200, East Hartford, CT, 06108, US

(21) Appl. No.: 12/084,674

(22) PCT Filed: Nov. 7, 2006
(86) PCT No.: PCT/GB2006/004120

§ 371 Date: May 6, 2008

(30) Foreign Application Priority Data
Nov. 11, 2005 (GB) 05 22 954.7

(51) Int. Cl. G06F 3/033

(52) U.S. Cl. 345/163; 345/157

(57) ABSTRACT

A switch controller 21 in the switching device receives input from a mouse 12 which is used to control movement of a pointer on a display connected to a host 20 which currently has focus. Each host is provided with a custom service 28 which monitors the position of the pointer via the system mouse controller 27 when the respective host has focus, and signals the switching device to change focus to another connected host when the pointer is moved to the edge of the screen. The controller 21 can also command the custom service 28 of the host which receives focus to reposition the pointer on the display. The communications between the switch controller 21 and the host 20 may be implemented using a standard USB HID driver.

### TECHNICAL FIELD OF THE INVENTION

This invention relates to computer switching devices of the kind which are used to change the focus of one or more user-interface devices between two or more host systems in such a way that only one host is focussed at any one time.

### BACKGROUND

A common form of computer switching device is a keyboard and mouse switch, which allows a user to control multiple host systems with a single keyboard and mouse. These host systems can be any piece of equipment that has a keyboard and mouse input, but is typically an IBM compatible PC, an Apple Mac, or a Sun workstation or server. Many keyboard and mouse switches also have the capability of switching additional communication channels from one host to another, such as audio, video and USB. The term “switch” is used, because only one of the attached host systems can be controlled at any one time, and so the user switches focus between the attached host systems.

The means of changing the focus of the user-interface devices between the attached host systems varies. Existing methods include the following:
Rotary dials: The focussed host system depends on the position of the dial.
Individual push buttons: Each attached host system has a dedicated button. Pushing a button focuses the keyboard and mouse on the appropriate host system.
Key sequences: The user presses keys on their keyboard in a set manner which is interpreted by the switch as a command to change the focus to a different host system. This may be a combination of keys such as Alt+Space+1, or a sequence of key presses such as a double tap of the Scroll Lock key.
Mouse commands: The user presses a predetermined combination of mouse buttons which the switch can interpret as a command to change the focus to a different host system. This may be a sequence such as holding down the middle mouse button and clicking the left button.

Mechanically-operated switches such as rotary dials or buttons tend to be unreliable and inconvenient, while keyboard or mouse commands require the user to memorise a command sequence.

The present invention seeks to provide a new and inventive way of invoking a focus change between host systems attached to the user-input device, which is more convenient and intuitive for the user.

### SUMMARY OF THE INVENTION

The present invention provides a computer switching device for changing the focus of one or more user-interface devices between two or more hosts in such a way that only one host has focus at any one time, in which each host has a display output and the switching device receives input from a pointing device which is used to control movement of a pointer on a display connected to the display output of the host which currently has focus, and each host is arranged to monitor the position of the pointer when the respective host has focus and signal the switching device to change focus to another connected host when the pointer executes a predetermined movement pattern.

Although various movement patterns can be used, it has been found that the most simple and intuitive method involves moving the pointer to the edge of the display.

The pointing device may be a computer mouse, trackball etc.

The switching device may additionally be arranged to signal the host to which focus is changed to reposition the mouse pointer.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic diagram of a multi-host computer installation which includes a computer switching device in accordance with the invention;

FIG. 2 is a schematic diagram showing part of the system in greater detail; and

FIG. 3 is a sequence diagram demonstrating the operation of the switching device.

### DETAILED DESCRIPTION OF THE DRAWINGS

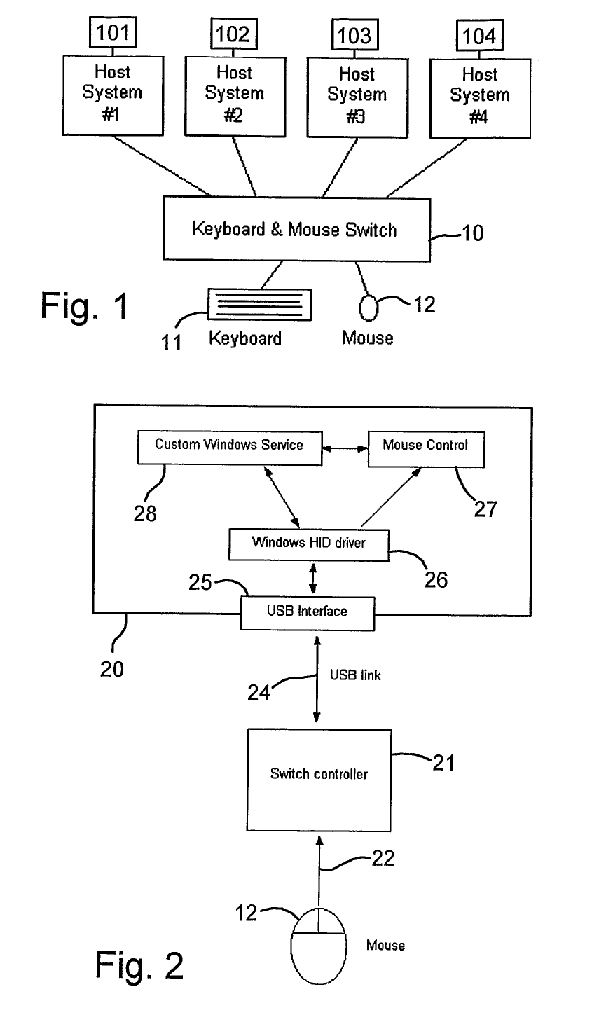

FIG. 1 shows a typical computer installation in which a four channel switch 10 is arranged to switch the focus of a keyboard 11 and mouse 12 between four host computer systems #1 to #4. The switch could also be arranged to change the focus of additional user-interface devices (not shown) in addition to the keyboard and mouse, such as a microphone and speakers, a common visual display device, etc. Also, the switch can be arranged to change focus between any number of host systems from two upwards. A host system is typically an IBM compatible PC, an Apple Mac, or a Sun workstation or server having a mouse and keyboard input and a display output to which a visual display screen 101-104 may be connected. In the present switching method the focus is changed when the user moves their mouse pointer to the edge of the display screen being used by the current host.

FIG. 2, shows the switching system as implemented in the switch and one of the hosts #1 to #4. The keyboard, any additional interface devices, and the other hosts, have all been omitted for clarity. The switch comprises a switch controller 21 which directs communications between the mouse 12 and the host 20 and also performs electronic switching of the various communication channels between the hosts and the user-input devices. Data which is sent from the mouse travels to the switch controller 21 along a one-way communication channel 22. It is important to note that data merely signals the relative movement of the mouse since the last movement report. This does not therefore allow the controller 21 to deduce the position of the mouse pointer on the screen of the host computer. However, by implementing the system described below the necessary switching control can be achieved.

The switch controller 21 has a two-way communication channel 24 with the software which is resident on the attached host 20. In the particular system which is being described here, the communication channel takes the form of a USB link via a USB interface 25 within the host 20, using standard HID class (human interface device) reports. The HID class is typically used by a HID driver 26, resident on the attached PC, to send movement information from an attached mouse 12 to a software mouse controller 27, normally integrated into the operating system, which moves the position of the mouse pointer on the display screen. However, the USB HID protocol has the ability to include vendor specific control and data messages, and this capability is used to open a bidirectional communication channel between the switch controller 21 and the HID driver 26. This is implemented in the way that the controller reports its HID capabilities to the attached PC during device enumeration. (Enumeration is a process controlled by the host system to enable it to recognise a newly connected USB peripheral and to discover it's capabilities.) The controller reports that it has standard keyboard capabilities, standard mouse capabilities and also vendor specific capabilities that include the ability for data to be sent from host to device as well as the normal direction from device to host.

An alternative implementation for the two-way communication channel 24 would be to specify a non-HID vendor specific communication channel. However, this would require a vendor specific device driver to be installed on the host PC rather than being able to utilise the standard HID driver that is automatically included on current PC operating systems such as Windows XP.

Returning to the present implementation, a custom Windows service 28 is installed on the host PC to be executed as the PC boots. This may be software installed by the user (e.g. from a CD, from the Internet or over a network) but it could also be uploaded to the PC from the switch 10. The Windows service 28 monitors the mouse movement activity via a communication channel 29 with the mouse controller 27 using standard Windows API calls, enabling the Windows service to compare the absolute mouse pointer position with the size of the display. The Windows service also communicates with the HID driver 26 so that the HID driver can send a report to inform the switch controller 21 whether the mouse pointer is touching the edge of the display or not.

In this implementation, the communication channels are also used to allow the switch controller 21 to command the Windows service 28 to reposition the mouse pointer by means of the mouse controller 27 when the host first receives focus. In a system where each of the hosts has a separate monitor 101-104, and the monitors are positioned side-by-side, this may, for example, re-position the mouse pointer at the same vertical position on the new monitor but at the opposite edge of the screen so that it the user appears to see the mouse pointer jump the gap between the display screens. Where the hosts use a single common monitor, controlled by the mouse switch for example, the new host may be instructed to place the mouse pointer in the same position which it occupied in the previously focussed host system.

The switch controller 21 may be arranged to support a separate USB HID interface for each of the attached hosts systems. When any HID reports are sent to the controller, the type of report and the source host system can be used to decide what action to take.

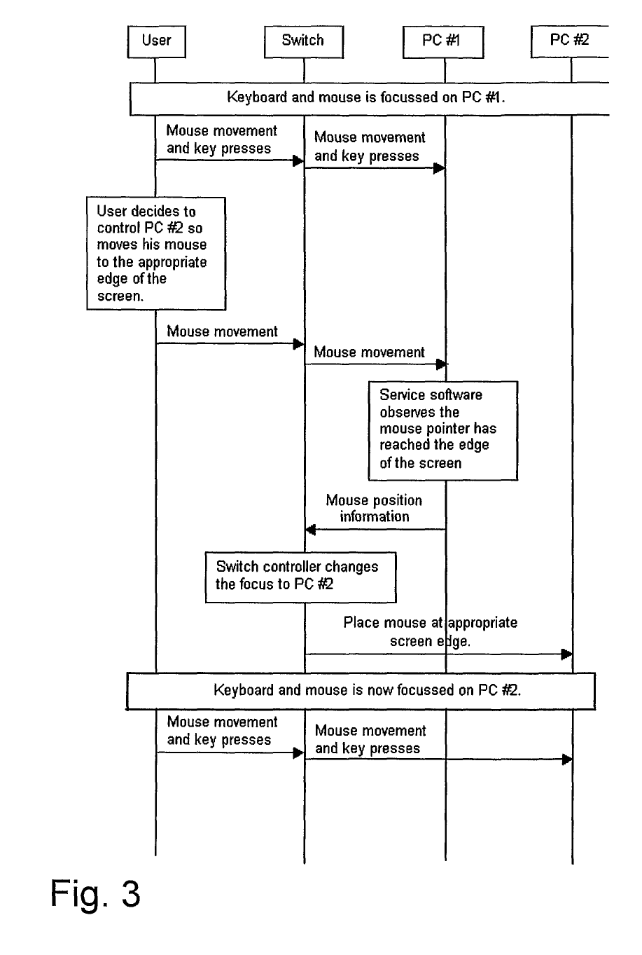

FIG. 3 shows the sequence of operations which take place when the user wishes to change focus from PC #1 to PC #2. Normal mouse movements and key presses are communicated from the user input to PC #1 via the controller 21 of switch 10. When the user moves the mouse pointer to the edge of their currently active display the software resident on the host system recognises that the pointer is positioned at the edge of the display and sends a message to the controller 21 within the switch. The switch controller then changes the focus of the keyboard, mouse and any other connected peripherals to a different host system, PC #2, and signals the new host to re-position the mouse pointer according to the position last occupied in the previous host PC #1.

The switch controller 21 may implement several methods for invoking a change of focus depending on the user's preference. Possible examples are:
The focus change takes place when the user moves the mouse pointer to the edge of the display and then keeps moving the mouse for a set period of time.
The focus change takes place when the user moves the mouse to the edge of the display, then away from the edge of the display and then back to the edge of the display in quick succession, within a predetermined period.
The focus change takes place immediately when the user moves the mouse to the edge of the screen.

Although the implementation described above uses the USB HID protocol as the communication path between the host PC and the switch controller, this could also be implemented in other PC operating systems such as Linux or Unix and on non-PC host systems, such as Apple Macs or Suns. A different communication method could be used between the host system and the switch controller when necessary, such as a PS/2 or RS232 link.

It will be appreciated that the features disclosed herein may be present in any feasible combination. Whilst the above description lays emphasis on those areas which, in combination, are believed to be new, protection is claimed for any inventive combination of the features disclosed herein.

1.-4. (canceled)

5. A computer switching device which is arranged to change the focus of one or more user-interface devices between two or more hosts in such a way that only one host has focus at any one time, in which each host has a display output and the switching device receives input from a pointing device which the switching device uses to control, via a bi-directional communication channel, movement of a pointer on a display connected to the display output of the host which currently has focus, and each host is arranged to monitor the position of the pointer when the respective host has focus and signal the switching device to change focus to another connected host when the pointer executes a predetermined movement pattern, in which each host has:
a pointer controller which controls the position of the pointer on the respective display;
a resident driver which receives movement information from the pointing device via the switching device and the bi-directional communication channel and sends said movement information to the pointer controller; and
a custom service which monitors movements of the pointer via the pointer controller and communicates with the resident driver to cause said driver to send a report to the switching device when the pointer executes the said movement pattern.

6. A computer switching device according to claim 5 in which the custom service of the host which currently has focus compares the pointer position with the size of the display area and signals the switching device to change focus to another host when the pointer moves to the edge of the display.

7. A computer switching device according to claim 5 in which the switching device is arranged to signal the custom service of the host to which focus is changed to reposition the pointer on the respective display.

8. A computer switching device according to claim 5 in which the pointing devices is a computer mouse.
